(19) United States
(12) Patent Application Publication
(10) Pub. No.: US 2013/0120557 A1
(43) Pub. Date: May 16, 2013

(54) PART INSPECTION SYSTEM

(71) Applicants: Steven J. King, Newfields, NH (US); Gerald I. Padnos, Cary, NC (US)

(72) Inventors: Steven J. King, Newfields, NH (US); Gerald I. Padnos, Cary, NC (US)

(73) Assignee: MICROSCAN SYSTEMS, INC., Renton, WA (US)

(21) Appl. No.: 13/532,526

(22) Filed: Jun. 25, 2012

Related U.S. Application Data
(60) Provisional application No. 61/559,648, filed on Nov. 14, 2011.

(51) Int. Cl. H04N 7/18

(52) U.S. Cl. 348/92; 348/E07.085

(57) ABSTRACT

An apparatus comprising an inspection window on which a part can be placed for inspection, a camera positioned to image the part through the inspection window, and one or more illuminators to illuminate the part.

### CROSS-REFERENCE TO RELATED APPLICATIONS

This application claims priority under the provisions of 35 U.S.C. § 119(e) to U.S. Provisional Application No. 61/559,648, filed 14 Nov. 2011 and still pending.

### TECHNICAL FIELD

The present invention relates generally to machine vision systems and in particular, but not exclusively, to a machine vision system for part inspection.

### BACKGROUND

Part inspection is a common application of machine vision. Ideally a part inspection system could inspect all kinds and sizes of parts completely automatically and without user intervention, but existing part inspection systems have limited flexibility and require frequent user intervention to adjust the system for different parts. This not only increases errors and operating costs, but also makes the inspection systems more expensive because adjustment mechanisms must be built into them.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a simplified schematic drawing of an embodiment of a part inspection system.

FIG. 2 is a simplified schematic drawing of an embodiment of a part inspection system.

FIG. 3 is a cross-sectional drawing of an embodiment of a part inspection system.

FIGS. 4A-4D are cross-sectional drawings of embodiments of inspection windows that can be used in the embodiments of a part inspection system shown in FIGS. 2-3.

FIGS. 5A and 5B are cross-sectional and perspective drawings, respectively, of an embodiment of a backlight illuminator that can be used in the embodiment of a part inspection system shown in FIG. 3.

FIGS. 6A and 6B are cross-sectional and perspective drawings, respectively, of an embodiment of a low-angle illuminator that can be used in the embodiment of a part inspection system shown in FIG. 3.

FIG. 7 is a cross-sectional drawing of an embodiment of an on-axis bright-field illuminator that can be used in the embodiment of a part inspection system shown in FIG. 3.

### DETAILED DESCRIPTION OF THE ILLUSTRATED EMBODIMENTS

Embodiments of an apparatus, system and method for part inspection are described. Numerous specific details are described to provide a thorough understanding of embodiments of the invention, but one skilled in the relevant art will recognize that the invention can be practiced without one or more of the specific details, or with other methods, components, materials, etc. In some instances, well-known structures, materials, or operations are not shown or described in detail but are nonetheless encompassed within the scope of the invention.

Reference throughout this specification to “one embodiment” or “an embodiment” means that a particular feature, structure, or characteristic described in connection with the embodiment is included in at least one described embodiment. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

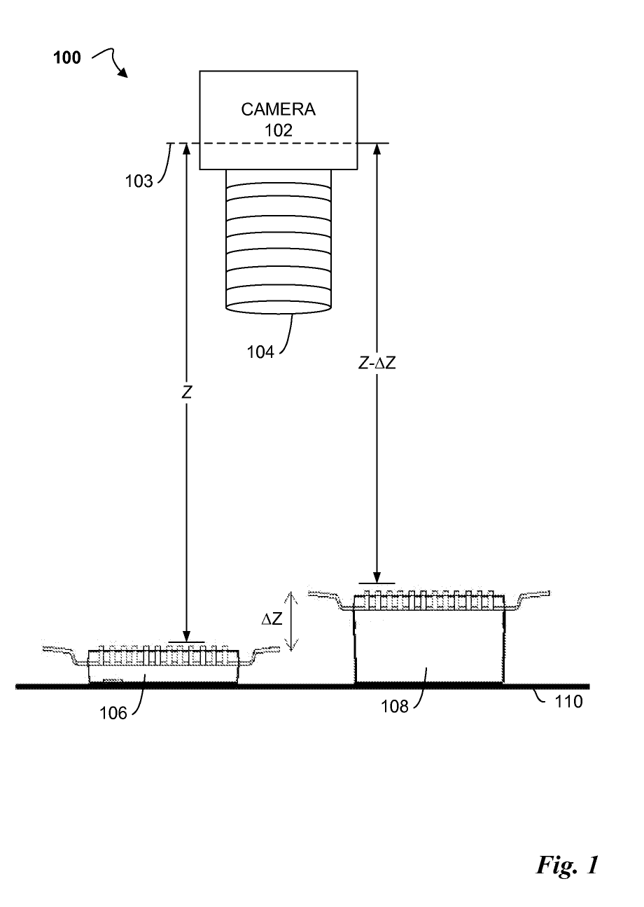

FIG. 1 illustrates a basic camera inspection system 100. In system 100, a camera 102 having optics 104 is positioned such that the image plane 103 of the camera is at a distance Z relative to a packaged integrated circuit 106 sitting on a surface 110. Distance Z can be pre-calibrated, taking into account the optical characteristics of optics 104, to provide a sharp image of relevant portions of packaged integrated circuit 106 so that the image can then be used for a machine-vision based inspection. If a different packaged integrated circuit 108 that differs in thickness from packaged integrated circuit 106 by an amount ΔZ is placed on surface 110, the distance between image plane 103 and the packaged integrated circuit is reduced by an amount ΔZ to Z-ΔZ.

Packaged integrated circuits such as 106 and 108 can be small, and the features of interest for inspection on the packages even smaller, such that optics 104 can have fairly high magnification. The high magnification means the depth of focus of the camera can be small, so that changing the distance between part and image plane 103 by ΔZ can make the captured image out of focus and unusable for machine vision analysis. The parts are also at a different distance from the camera, meaning that for a lens with parallax the tall part 108 and the short part 106 will have different apparent dimensions. As a result, when parts to be inspected vary by a height ΔZ, the camera operator must usually adjust the distance between camera 102 and the part so that the distance between image plane 103 and the part being inspected remains substantially equal to Z. In other words, if the thickness of the part changes by ΔZ, the camera must also be moved a corresponding amount to maintain optimum focus. To put both parts at the calibration plane also means moving Z. Constantly adjusting the Z position of the camera introduces errors into the system, uses valuable operator time, and makes the imaging more expensive because the ability for the camera to be moved in the Z direction must be built into the system.

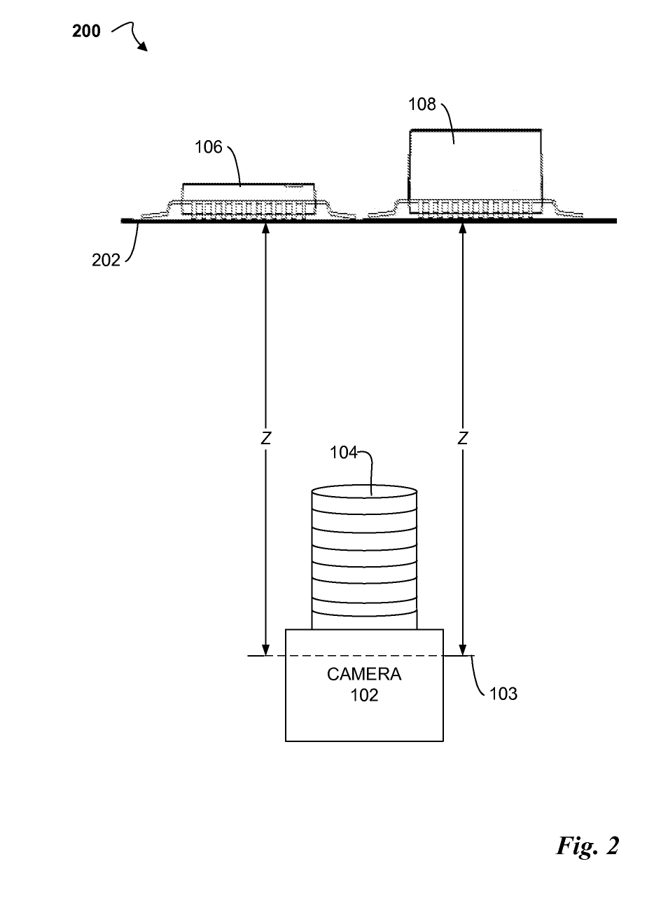

FIG. 2 illustrates an alternative embodiment of a simplified inspection system 200. In system 200, packaged integrated circuits 106 and 108 are positioned on an inspection window 202 such that the parts of the packaged integrated circuits of greatest interest for inspection—in the illustrated embodiment, the package leads—are in contact with the inspection window. All the parts to be inspected therefore have a common datum established by the surface of inspection window 202. Camera 102 is positioned so that it images packaged integrated circuits 106 and 108 through inspection window 202. As a result of positioning the packaged integrated circuits 106 and 108 such that the parts of greatest interest for inspection are in contact with the inspection window, the distance Z between the image plane 103 and the part remains substantially constant, so that there is no need to adjust the position of camera 102 every time the dimension of the part being inspected changes.

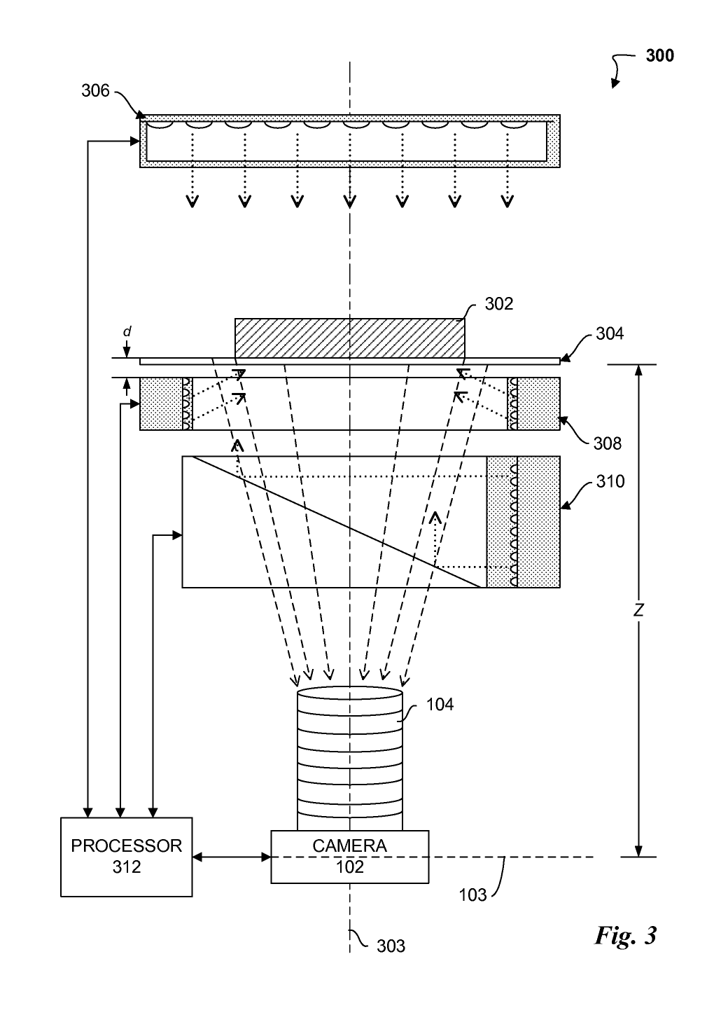

FIG. 3 illustrates an embodiment of an inspection system 300. In system 300, a part 302 is positioned on an inspection window 304 such that the portions of part 302 that are to be inspected are in contact or near-contact with the top surface of inspection window 304. Camera 102 and optics 104 are positioned on the side of inspection window 304 opposite the side on which part 304 is placed, with part 302 on or near the optical axis 303 of camera 102, so that camera 102 can capture an image of part 302 through inspection window 304. Part 302 can be any kind of part to be inspected; examples include integrated circuit package types such as Quad Flat Package(QFP), Ball Grid Array (BGA), Chip Scale Package (CSP), Quad-Flat No-leads (QFN), Small Outline Packages (SOP, LSOP, TSOP) as well as a variety of connector type and heat sinks. In the illustrated embodiment an entire surface of part 302 is in contact with the inspection window, but in different embodiments it need not be the case that an entire surface of the part is in contact with the window (see FIG. 2)

In the illustrated embodiment three illuminators are positioned relative to inspection window 304 to provide different kinds of illumination for part 302: a backlight 306, a low-angle (dark field) illuminator 308, and an on-axis (bright field) illuminator 310. Other embodiments of system 300 can, of course, include fewer than all of the illustrated illuminators. For instance, certain types of inspections can be performed with a low-angle illuminator and on on-axis illuminator, but without a backlight illuminator. Other embodiments can use only one of the illustrated illuminators individually, or can use any combination of two or more of the illustrated illuminators. Still other embodiments can include no illuminators at all, relying on ambient light for the necessary lighting (see FIG. 2), or can include illuminators altogether different than the ones shown. Finally, although the illuminators are described as directing “light” toward the object to be imaged, this does not restrict the illuminators to visible wavelength of light; illuminators that output wavelengths outside the visible spectrum, such as infrared and ultraviolet, can also be used

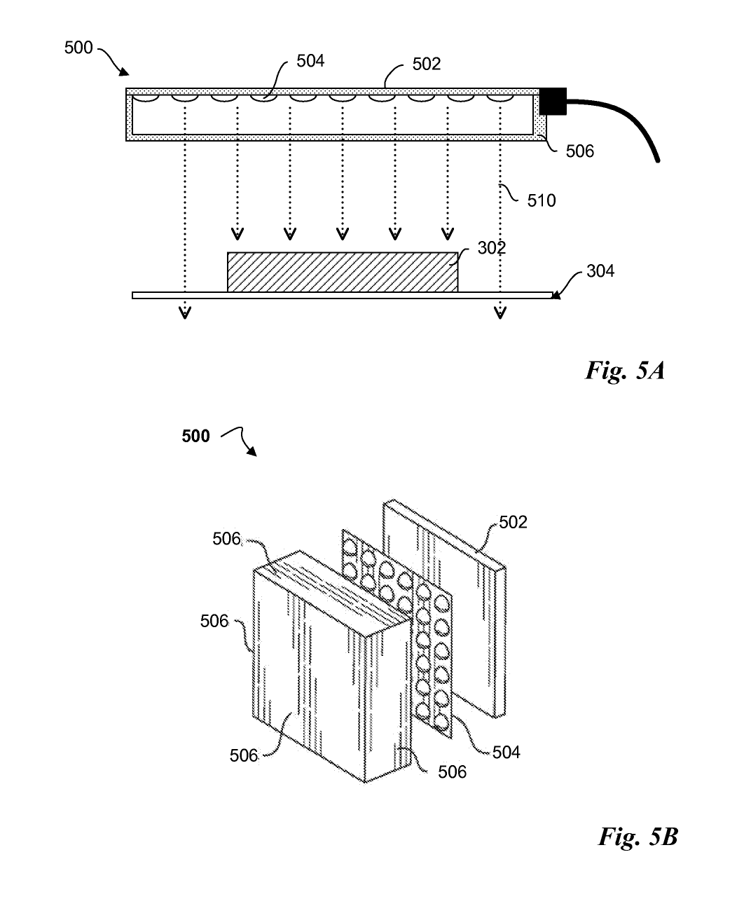

Backlight illuminator 306 is positioned on the side of inspection window 304 opposite the camera is and aimed so that its light is directed toward the camera, hence backlighting part 302 as seen by the camera. Backlight illuminator 306 can provide a silhouette image of part 302, which can be useful in analyzing the part's outline. In one embodiment backlight illuminator 306 is a diffuse light source that provides even and diffuse backlight to part 302 (see FIG. 5), but in other embodiments other types of backlight can be used.

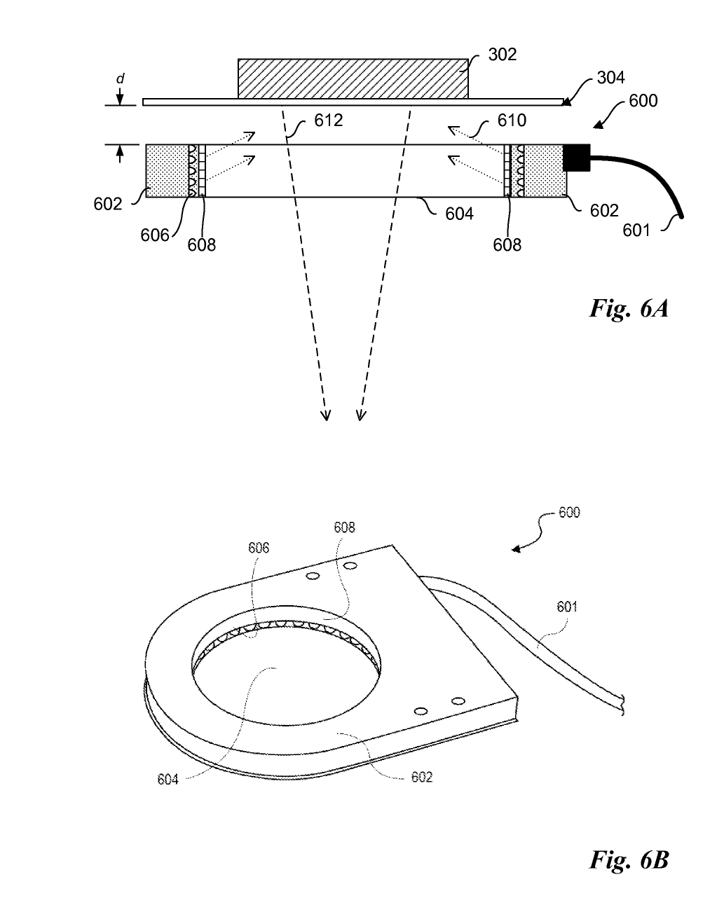

Low-angle illuminator 308 is positioned on the same side of inspection window 304 as camera 102, with a distance d between the low-angle light and the surface of the inspection window on which part 302 is placed. The incidence angle of the low-angle light from illuminator 308 upon inspection window 304, and hence the angle of incidence upon part 302, can be adjusted within a certain range by varying the distance d. In one embodiment low-angle illuminator 308 is a ring-type illuminator with a central opening that allows camera 102 to capture light reflected from part 302 through the central opening (see FIG. 6), but in other embodiments other types of low-angle illuminator can be used.

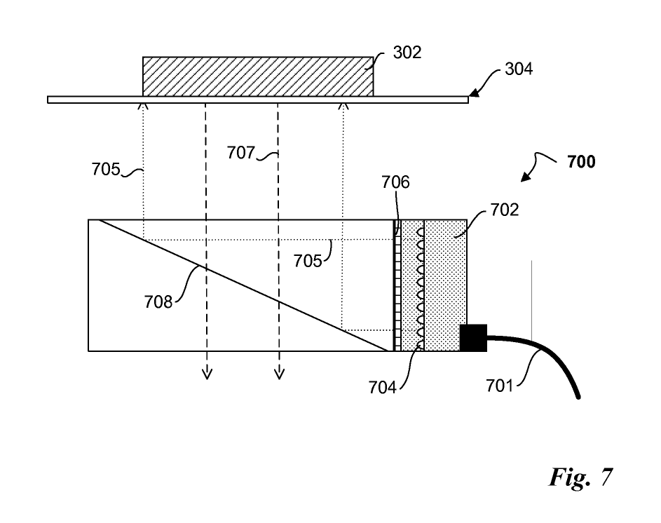

On-axis bright-field illuminator 310 is positioned between camera 102 and low-angle illuminator 308, such that its light is directed toward inspection window 304, and through inspection window 304 to part 302, substantially along and about optical axis 303. In the illustrated embodiment, bright-field illuminator 310 includes optics therein that direct the bright-field light toward inspection window 304 and part 302 while allowing light reflected from part 302 to travel through illuminator 310 so that it can be imaged by camera 102 (see FIG. 7). In other embodiments, other types of on-axis light can be used.

Processor 312 can be coupled to camera 102 to receive and analyze imaged captured by the camera. Although not illustrated in the figure, processor 312 can include other elements such as memory and storage. Processor 312 can also be coupled to backlight 306, low-angle illuminator 308 and on-axis illuminator 310, so that it can automatically control which illuminator or combination of illuminators is on at any given time. Processor 312 can also, for example based on analysis of images captured by camera 102, adjust the intensity of the light from one or more of the illuminators to improve the quality of captured images of part 302.

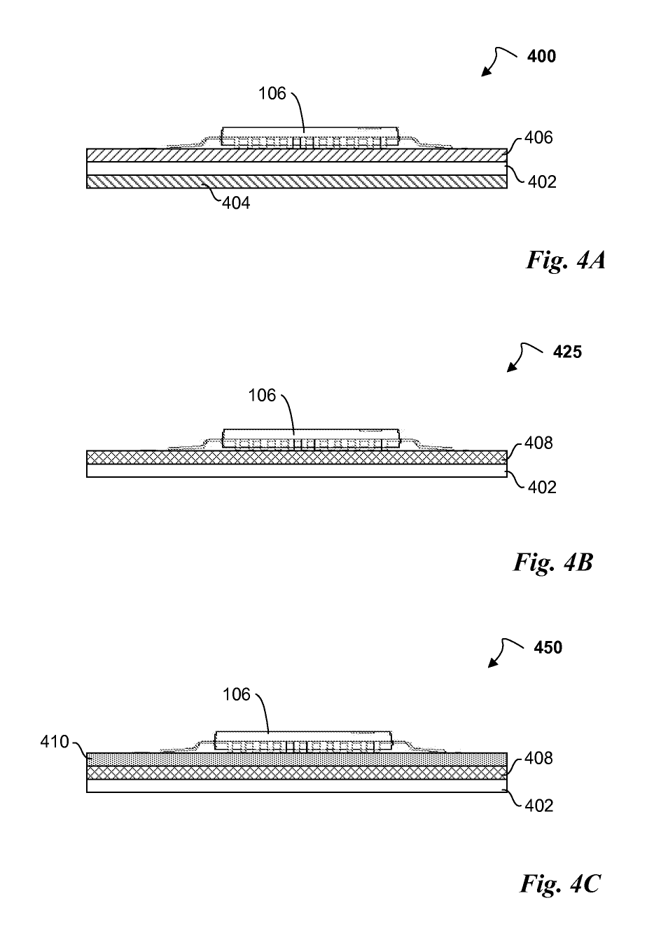

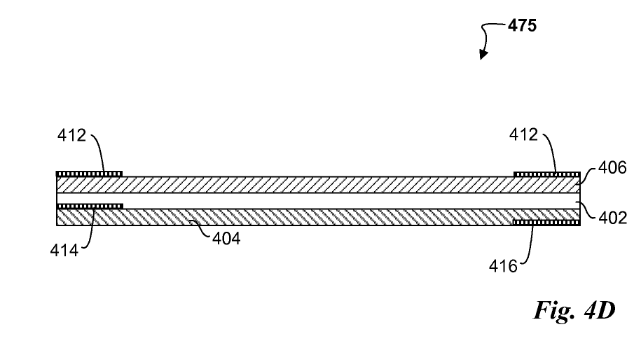

FIGS. 4A-4D illustrate embodiments of inspection windows that can be used, for example, as inspection window 202 or inspection window 304. Generally, the inspection window should be substantially planar, substantially free of optical distortion, and substantially optically transparent in the wavelengths of interest and the surface of viewing window on which the package to be inspected rests can be a hard, cleanable surface that can be kept dust-free. The embodiments described below include various coatings on a substantially planar, substantially distortion-free, and substantially optically transparent substrate, but in other embodiments a similar substrate can be used without any coatings.

FIG. 4A illustrates a first embodiment of an inspection window 400. Inspection window 400 includes a substrate 402 that is optically transparent in the wavelength range of interest. In one embodiment substrate 402 can be made of an optical-grade plastic such as acrylic or polycarbonate, but in other embodiments substrate 402 can be a different optical-grade material, such as glass. An anti-reflection coating 404 is formed on the side of substrate 402 that will face toward the camera, while an anti-scratch coating 406 can be formed on the side of substrate 402 on which the part to be inspected will rest. Anti-scratch coating 406 eliminates or reduces scratches on the inspection window that would affect the quality of the captured images. In embodiments in which substrate 402 is a hard material such as glass, anti-scratch coating 406 can be omitted. In the illustrated embodiment part 302 is a packaged integrated circuit 106, but of course part 302 can be any kind of part.

FIG. 4B illustrates another embodiment of an inspection window 425. Inspection window 425 also includes substrate 402, but instead of using separate anti-scratch and anti-reflection coatings, inspection window 425 combines the two into a single coating 408 that is hard enough to provide anti-scratch protection while still providing the anti-reflection function. In one embodiment, coating 408 is a coating such as Duravue 7000, made by TSP Inc. of Batavia, Ohio, which is much harder than standard anti-reflection coatings such as coating 404 in inspection window 400. Other types of coatings can, of course, be used in other embodiments.

FIG. 4C illustrates another embodiment of an inspection window 450. Inspection window 450 is in most respects similar to inspection window 425, except that inspection window 450 also includes an additional anti-static layer 410 on top of anti-reflection/anti-scratch layer 408. Anti-static layer 410 prevents build-up of static electricity on inspection window 450, so that when part 302 is an item such as an integrated circuit it will not be damaged by a static discharge.

FIG. 4D illustrates another embodiment of an inspection window 475. Inspection window 475 is in most respects similar to inspection window 400, except that inspection window 475 also includes one or more calibration features. When inspection window 475 is used as inspection window 202 in system 200 or inspection window 304 in system 300, the one or more calibration features allow the system to be calibrated before putting the item to be inspected, such as items 106 and 108 (FIG. 2) and item 302 (FIG. 3), on the inspection window. Inspection window 475 illustrates the use of calibration targets in a window similar in construction to inspection window 400 (FIG. 4A), but calibration targets can be similarly used and/or similarly positioned in other inspection windows constructions, such as inspection windows 425 (FIG. 4B) and 450 (FIG. 4C).

In the illustrated embodiment, the calibration features used in inspection window 475 include calibration targets 412 positioned in or on the anti-scratch coating 406 such that the targets are on the surface of inspection window 475 on which the part to be inspected will be placed. One or more calibration targets 414 can also be placed in or on substrate 402 and similarly one or more calibration targets 416 can be placed in or on anti-reflection coating 404. Other embodiments need not include every one of the illustrated calibration targets, but can instead include as few as one of the calibration targets shown, or can include any combination of two or more of the target shown. For example, one embodiment may include only calibration targets 412 and none of the others; another embodiment may include only calibration targets 416 and 414; and so forth. Different or additional targets and/or target positions than those illustrated can also be used in still other embodiments; for example, the illustrated targets are positioned near the edges of inspection window 475, but in other embodiments the calibration targets could be positioned at any other location in the window, for example at or near the window's center

In one embodiment, the calibration target can be a removable target that can be positioned on the exterior of inspection window 475, but in other embodiments the calibration target can be permanently fixed in the window, such as by etching it into optically transparent substrate 402, anti-reflective layer 404, or anti-scratch layer 406. In still other embodiments, one or more of the calibration targets can be embedded into the interior of optically transparent substrate 402, anti-reflective layer 404, or anti-scratch layer 406 at the appropriate time during manufacture of inspection window 475.

FIGS. 5A-5B together illustrate an embodiment of a backside illuminator 500 that can be used as backlight illuminator 306 in an embodiment of system 300, but of course other differently-configured backside illuminators can be used in other embodiments of system 300. Backlight illuminator 300 includes a plurality of individual light sources 504, such as light-emitting diodes (LEDs) mounted on a plate 502 that can provide electrical connections for the individual LEDs as well as providing a heat sink to transfer heat generated by the individual light sources. An optical element 506 is positioned over light sources 504 to condition the light as it leaves the illuminator. In one embodiment optical element 506 can be a diffuser, but in other embodiments optical element 506 can be another type of optical element, such as one with optical power that can collimate light. In still other embodiments, optical element 506 can be a combination of optical elements, such as a combination that both collimates and diffuses light. A commercially-available example of a backlight illuminator is the model BL 100X100 made by Microscan Systems, Inc., of Renton, Wash.

FIGS. 6A-6B together illustrate an embodiment of a low-angle (dark field) illuminator 600 that can be used as illuminator 308 in an embodiment of system 300, but of course other differently-configured low-angle illuminators can be used in other embodiments of system 300. Low-angle illuminator 600 is a ring-type illuminator that includes a ring 602 surrounding an open circular region 604. Open circular region 604 allows light reflected from the object that illuminator 604 is used to illuminate to pass through so that it can be imaged with a camera. Within ring 602 and around the perimeter of open circular region 604 are a plurality of light sources 606. An additional optical element 608 can be positioned between light sources 606 and open circular region 604 to condition the light emitted by light sources 606. In one embodiment optical element 608 can be a diffuser, but in other embodiments optical element 608 can be another type of optical element, such as one with optical power that can collimate light, or can be a combination of optical elements, such as a combination that both collimates and diffuses light. A commercially-available example of a ring-type low-angle illuminator is the model DF-150-1 made by Microscan Systems, Inc., of Renton, Wash.

FIG. 7 illustrates an embodiment of an on-axis illuminator 700 that can be used as on-axis illuminator 310 in an embodiment of system 300, but of course other differently-configured on-axis illuminators can be used in other embodiments of system 300. On-axis illuminator 700 includes a housing 702 within which are a plurality of individual light sources 704 such as light-emitting diodes (LEDs). An optical element 708 is positioned within housing 702 to receive light 705 from light sources 704 and re-direct light 705 toward the object being imaged, such as part 302 on inspection window 304. Optical element 708 simultaneously receives light 707 reflected from the object being illuminated and allows it to pass through so that it can be imaged. In one embodiment, optical element 708 can be a beamsplitter, but in other embodiments it can be another type of optical element, such as a partially reflective mirror.

An additional optical element 706 can be positioned between light sources 704 and optical element 708 to condition the light emitted by light sources 704. In one embodiment optical element 706 can be a diffuser, but in other embodiments optical element 706 can be another type of optical element, such as one with optical power that can collimate light, or can be a combination of optical elements, such as a combination that both collimates and diffuses light. A commercially-available example of an on-axis illuminator is model DOAL-100 made by Microscan Systems, Inc., of Renton, Wash.

The above description of illustrated embodiments of the invention, including what is described in the abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. An apparatus comprising:
an inspection window on which a part can be placed for inspection such that at least a portion of the part is in contact with the inspection window; and
a camera positioned to image the part through the inspection window, wherein the camera is positioned at a fixed distance from the inspection window.

2. The apparatus of claim 1, further comprising one or more illuminators to illuminate the part.

3. The apparatus of claim 2 wherein the one or more illuminators include at least one illuminator selected from a group consisting of:
a backlight illuminator positioned on the side of the inspection window on which the part can be placed and oriented to direct light toward the camera;
a low-angle illuminator positioned at a specified distance from the inspection window on the side of the inspection window that faces the camera and oriented to direct low-angle light through the inspection window; and
an on-axis illuminator positioned along the optical axis of the camera to direct bright-field light through the inspection window and to allow light reflected from the part, if present, to travel to the camera.

4. The system of claim 3 wherein the specified distance can be varied to vary the angle of the low-angle light relative to the inspection window.

5. The apparatus of claim 1 wherein the inspection window comprises an optically transparent substrate.

6. The apparatus of claim 5 wherein the inspection window further comprises an anti-reflective coating, an anti-scratch coating, or both, on the optically transparent substrate.

7. The apparatus of claim 6 wherein the inspection window further comprises an anti-static coating on the anti-reflective coating.

8. The apparatus of claim 1 wherein the inspection window includes one or more calibration targets.

9. An inspection system comprising:
an inspection window on which a part can be placed for inspection such that at least a portion of the part is in contact with the inspection window;
a camera positioned to image the part through the inspection window, wherein the camera is positioned at a fixed distance from the inspection window;
one or more illuminators to illuminate the part; and
a processor coupled to the camera and to at least one of the one or more illuminators.

10. The system of claim 9 wherein the one or more illuminators include at least one illuminator selected from a group consisting of:
a backlight illuminator positioned on the side of the inspection window on which the part can be placed and oriented to direct light toward the camera;
a low-angle illuminator positioned at a specified distance from the inspection window on the side of the inspection window that faces the camera and oriented to direct low-angle light through the inspection window; and
an on-axis illuminator positioned along the optical axis of the camera to direct bright-field light through the inspection window and to allow light reflected from the part, if present, to travel to the camera.

11. The system of claim 10 wherein the specified distance can be varied to vary the angle of the low-angle light relative to the inspection window.

12. The system of claim 9 wherein the inspection window comprises an optically transparent substrate.

13. The system of claim 12 wherein the inspection window further comprises an anti-reflective coating, an anti-scratch coating, or both, on the optically transparent substrate.

14. The system of claim 13 wherein the anti-reflective coating is a hard, scratch-resistant coating.

15. The system of claim 13 wherein the inspection window further comprises an anti-static coating on the anti-reflective coating.

16. The system of claim 9 wherein the inspection window includes one or more calibration targets.

17. The system of claim 9 wherein the processor can selectively activate or deactivate at least one of the one or more illuminators.

18. The system of claim 9 wherein the processor can analyze the image of the part captured by the camera and selectively activate or deactivate at least one of the one or more illuminators based on its analysis of the image.

19. An inspection process comprising:
placing a part on an inspection window such that at least a portion of the part is in contact with the inspection window; and
imaging the part through the inspection window using a camera positioned at a fixed distance from the inspection window.

20. The process of claim 19, further comprising illuminating the part using one or more illuminators.

21. The process of claim 20 wherein the one or more illuminators include at least one illuminator selected from a group consisting of:
a backlight illuminator positioned on the side of the inspection window on which the part can be placed and oriented to direct light toward the camera;
a low-angle illuminator positioned at a specified distance from the inspection window on the side of the inspection window that faces the camera and oriented to direct low-angle light through the inspection window; and
an on-axis illuminator positioned along the optical axis of the camera to direct bright-field light through the inspection window and to allow light reflected from the part, if present, to travel to the camera.

22. The process of claim 21, further comprising varying the angle of the low-angle light relative to the inspection window by varying the specified distance.

23. The process of claim 20, further comprising selectively activating or deactivating at least one of the one or more illuminators.

24. The process of claim 20, further comprising analyzing the image of the part captured by the camera and selectively activating or deactivating at least one of the one or more illuminators based on its analysis of the image.

25. The process of claim 19 wherein the inspection window comprises an optically transparent substrate.

26. The process of claim 25 wherein the inspection window further comprises an anti-reflective coating, an anti-scratch coating, or both, on the optically transparent substrate.

27. The process of claim 26 wherein the anti-reflective coating is a hard, scratch-resistant coating.

28. The process of claim 26 wherein the inspection window further comprises an anti-static coating on the anti-reflective coating.

29. The process of claim 19, further comprising calibrating the camera using one or more calibration targets positioned in or on the inspection window.
